(19) United States
(12) Patent Application Publication
(10) Pub. No.: US 2020/0074352 A1
(43) Pub. Date: Mar. 5, 2020

(54) PRESENTING MEETING OPTIONS ASSOCIATED WITH TRIPS

(71) Applicant: Oath Inc., New York, NY (US)

(72) Inventors: Mohit Goenka, Santa Clara, CA (US); Nikita Varma, Milpitas, CA (US); Ashish Khushal Dharamshi, Sunnyvale, CA (US)

(21) Appl. No.: 16/118,968

(22) Filed: Aug. 31, 2018

(51) Int. Cl. G06Q 10/02; G06F 3/0482; G06Q 10/10

(52) U.S. Cl. CPC G06Q 10/02; H04L 67/12; G06Q 10/1095; G06F 3/0482

(57) ABSTRACT

One or more computing devices, systems, and/or methods for presenting meeting options associated with trips are provided. For example, a location and/or a time associated with a trip of a user may be determined. A first location profile associated with the user may be generated based upon the location and/or the time. A plurality of location profiles, associated with a plurality of user accounts, may be compared with the first location profile. It may be determined that one or more location profiles of the plurality of location profiles, associated with one or more user accounts, are associated with one or more locations and/or one or more times that match the location and/or the time. A notification, indicative of the one or more locations and/or the one or more times matching the location and/or the time, may be transmitted to a first client device associated with the user.

### BACKGROUND

Many services, such as scheduling services (e.g., web-based calendars), email services, instant messaging services, social network services, hotel reservation services, flight reservation services, etc. may allow a user to schedule trips, disclose travel plans to contacts, reserve flights to destinations and/or reserve hotels at destinations. For example, the user may plan a trip to a location using one or more services. However, the user may not know people and/or events at the location. Thus, the user may not make effective use of their limited time while at the location.

### SUMMARY

In accordance with the present disclosure, one or more computing devices and/or methods are provided. In an example, a location associated with a trip of a first user may be determined. The first user may be associated with a first user account. A time associated with the trip of the first user to the location may be determined. A first location profile associated with the first user account may be generated based upon the location and the time. The first location profile may comprise one or more locations associated with the first user and one or more times corresponding to the one or more locations. A plurality of user accounts having a relationship with the first user account may be determined. A plurality of location profiles associated with the plurality of user accounts may be compared with the first location profile. It may be determined that one or more location profiles, associated with one or more user accounts of the plurality of user accounts, are associated with one or more second locations and one or more second times that match the location and the time. The plurality of location profiles may comprise the one or more location profiles. Responsive to determining that the one or more second locations and the one or more second times match the location and the time, a notification may be transmitted to a first client device associated with the first user account. The notification may be indicative of the one or more second locations and the one or more second times matching the location and the time.

### DESCRIPTION OF THE DRAWINGS

While the techniques presented herein may be embodied in alternative forms, the particular embodiments illustrated in the drawings are only a few examples that are supplemental of the description provided herein. These embodiments are not to be interpreted in a limiting manner, such as limiting the claims appended hereto.

FIG. 1 is an illustration of a scenario involving various examples of networks that may connect servers and clients.

FIG. 2 is an illustration of a scenario involving an example configuration of a server that may utilize and/or implement at least a portion of the techniques presented herein.

FIG. 3 is an illustration of a scenario involving an example configuration of a client that may utilize and/or implement at least a portion of the techniques presented herein.

FIG. 4 is a flow chart illustrating an example method for presenting meeting options associated with a trip.

FIG. 5A is a component block diagram illustrating an example system for presenting meeting options associated with a trip, where a graphical user interface of a first client device is controlled to display a calendar interface.

FIG. 5B is a component block diagram illustrating an example system for presenting meeting options associated with a trip, where a calendar interface displays a plurality of selectable inputs associated with a calendar event.

FIG. 5C is a component block diagram illustrating an example system for presenting meeting options associated with a trip, where a backend system generates a first location profile associated with a first user account of a user and/or compares the first location profile with a plurality of location profiles.

FIG. 5D is a component block diagram illustrating an example system for presenting meeting options associated with a trip, where a graphical user interface of a first client device is controlled to display a notification indicative of a second location and/or a second time matching a location and/or a time of a trip of a user.

FIG. 5E is a component block diagram illustrating an example system for presenting meeting options associated with a trip, where a graphical user interface of a first client device is controlled to display a plurality of times associated with an availability of a contact.

FIG. 5F is a component block diagram illustrating an example system for presenting meeting options associated with a trip, where a second graphical user interface of a second client device is controlled to display a second notification.

FIG. 5G is a component block diagram illustrating an example system for presenting meeting options associated with a trip, where a graphical user interface of a first client device is controlled to display a plurality of items.

FIG. 6 is an illustration of a scenario featuring an example non-transitory machine readable medium in accordance with one or more of the provisions set forth herein.

### DETAILED DESCRIPTION

Subject matter will now be described more fully hereinafter with reference to the accompanying drawings, which form a part hereof, and which show, by way of illustration, specific example embodiments. This description is not intended as an extensive or detailed discussion of known concepts. Details that are known generally to those of ordinary skill in the relevant art may have been omitted, or may be handled in summary fashion.

The following subject matter may be embodied in a variety of different forms, such as methods, devices, components, and/or systems. Accordingly, this subject matter is not intended to be construed as limited to any example embodiments set forth herein. Rather, example embodiments are provided merely to be illustrative. Such embodiments may, for example, take the form of hardware, software, firmware or any combination thereof.

1. Computing Scenario

The following provides a discussion of some types of computing scenarios in which the disclosed subject matter may be utilized and/or implemented.

1.1. Networking

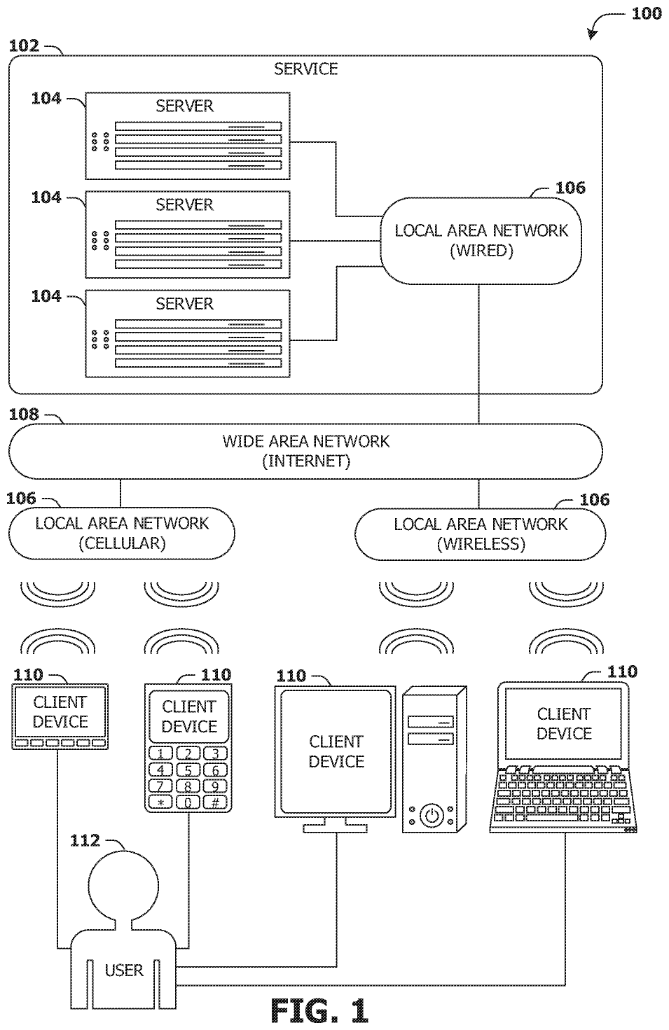

FIG. 1 is an interaction diagram of a scenario 100 illustrating a service 102 provided by a set of servers 104 to a set of client devices 110 via various types of networks. The servers 104 and/or client devices 110 may be capable of transmitting, receiving, processing, and/or storing many types of signals, such as in memory as physical memory states.

The servers 104 of the service 102 may be internally connected via a local area network 106 (LAN), such as a wired network where network adapters on the respective servers 104 are interconnected via cables (e.g., coaxial and/or fiber optic cabling), and may be connected in various topologies (e.g., buses, token rings, meshes, and/or trees). The servers 104 may be interconnected directly, or through one or more other networking devices, such as routers, switches, and/or repeaters. The servers 104 may utilize a variety of physical networking protocols (e.g., Ethernet and/or Fiber Channel) and/or logical networking protocols (e.g., variants of an Internet Protocol (IP), a Transmission Control Protocol (TCP), and/or a User Datagram Protocol (UDP). The local area network 106 may include, e.g., analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links including satellite links, or other communication links or channels, such as may be known to those skilled in the art. The local area network 106 may be organized according to one or more network architectures, such as server/client, peer-to-peer, and/or mesh architectures, and/or a variety of roles, such as administrative servers, authentication servers, security monitor servers, data stores for objects such as files and databases, business logic servers, time synchronization servers, and/or front-end servers providing a user-facing interface for the service 102.

Likewise, the local area network 106 may comprise one or more sub-networks, such as may employ differing architectures, may be compliant or compatible with differing protocols and/or may interoperate within the local area network 106. Additionally, a variety of local area networks 106 may be interconnected; e.g., a router may provide a link between otherwise separate and independent local area networks 106.

In the scenario 100 of FIG. 1, the local area network 106 of the service 102 is connected to a wide area network 108 (WAN) that allows the service 102 to exchange data with other services 102 and/or client devices 110. The wide area network 108 may encompass various combinations of devices with varying levels of distribution and exposure, such as a public wide-area network (e.g., the Internet) and/or a private network (e.g., a virtual private network (VPN) of a distributed enterprise).

In the scenario 100 of FIG. 1, the service 102 may be accessed via the wide area network 108 by a user 112 of one or more client devices 110, such as a portable media player (e.g., an electronic text reader, an audio device, or a portable gaming, exercise, or navigation device); a portable communication device (e.g., a camera, a phone, a wearable or a text chatting device); a workstation; and/or a laptop form factor computer. The respective client devices 110 may communicate with the service 102 via various connections to the wide area network 108. As a first such example, one or more client devices 110 may comprise a cellular communicator and may communicate with the service 102 by connecting to the wide area network 108 via a wireless local area network 106 provided by a cellular provider. As a second such example, one or more client devices 110 may communicate with the service 102 by connecting to the wide area network 108 via a wireless local area network 106 provided by a location such as the user's home or workplace (e.g., a WiFi (Institute of Electrical and Electronics Engineers (IEEE) Standard 802.11) network or a Bluetooth (IEEE Standard 802.15.1) personal area network). In this manner, the servers 104 and the client devices 110 may communicate over various types of networks. Other types of networks that may be accessed by the servers 104 and/or client devices 110 include mass storage, such as network attached storage (NAS), a storage area network (SAN), or other forms of computer or machine readable media.

1.2. Server Configuration

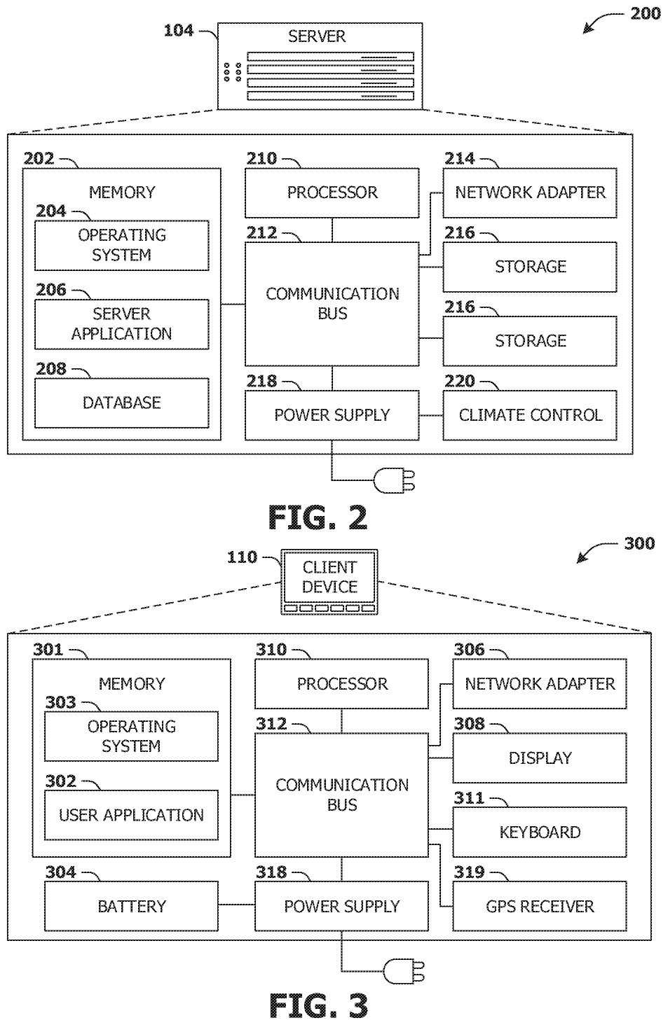

FIG. 2 presents a schematic architecture diagram 200 of a server 104 that may utilize at least a portion of the techniques provided herein. Such a server 104 may vary widely in configuration or capabilities, alone or in conjunction with other servers, in order to provide a service such as the service 102.

The server 104 may comprise one or more processors 210 that process instructions. The one or more processors 210 may optionally include a plurality of cores; one or more coprocessors, such as a mathematics coprocessor or an integrated graphical processing unit (GPU); and/or one or more layers of local cache memory. The server 104 may comprise memory 202 storing various forms of applications, such as an operating system 204; one or more server applications 206, such as a hypertext transport protocol (HTTP) server, a file transfer protocol (FTP) server, or a simple mail transport protocol (SMTP) server; and/or various forms of data, such as a database 208 or a file system. The server 104 may comprise a variety of peripheral components, such as a wired and/or wireless network adapter 214 connectible to a local area network and/or wide area network; one or more storage components 216, such as a hard disk drive, a solid-state storage device (SSD), a flash memory device, and/or a magnetic and/or optical disk reader.

The server 104 may comprise a mainboard featuring one or more communication buses 212 that interconnect the processor 210, the memory 202, and various peripherals, using a variety of bus technologies, such as a variant of a serial or parallel AT Attachment (ATA) bus protocol; a Uniform Serial Bus (USB) protocol; and/or Small Computer System Interface (SCI) bus protocol. In a multibus scenario, a communication bus 212 may interconnect the server 104 with at least one other server. Other components that may optionally be included with the server 104 (though not shown in the schematic diagram 200 of FIG. 2) include a display; a display adapter, such as a graphical processing unit (GPU); input peripherals, such as a keyboard and/or mouse; and a flash memory device that may store a basic input/output system (BIOS) routine that facilitates booting the server 104 to a state of readiness.

The server 104 may operate in various physical enclosures, such as a desktop or tower, and/or may be integrated with a display as an “all-in-one” device. The server 104 may be mounted horizontally and/or in a cabinet or rack, and/or may simply comprise an interconnected set of components. The server 104 may comprise a dedicated and/or shared power supply 218 that supplies and/or regulates power for the other components. The server 104 may provide power to and/or receive power from another server and/or other devices. The server 104 may comprise a shared and/or dedicated climate control unit 220 that regulates climate properties, such as temperature, humidity, and/or airflow. Many such servers 104 may be configured and/or adapted to utilize at least a portion of the techniques presented herein.

1.3. Client Device Configuration

FIG. 3 presents a schematic architecture diagram 300 of a client device 110 whereupon at least a portion of the techniques presented herein may be implemented. Such a client device 110 may vary widely in configuration or capabilities, in order to provide a variety of functionality to a user such as the user 112. The client device 110 may be provided in a variety of form factors, such as a desktop or tower workstation; an “all-in-one” device integrated with a display 308; a laptop, tablet, convertible tablet, or palmtop device; a wearable device mountable in a headset, eyeglass, earpiece, and/or wristwatch, and/or integrated with an article of clothing; and/or a component of a piece of furniture, such as a tabletop, and/or of another device, such as a vehicle or residence. The client device 110 may serve the user in a variety of roles, such as a workstation, kiosk, media player, gaming device, and/or appliance.

The client device 110 may comprise one or more processors 310 that process instructions. The one or more processors 310 may optionally include a plurality of cores; one or more coprocessors, such as a mathematics coprocessor or an integrated graphical processing unit (GPU); and/or one or more layers of local cache memory. The client device 110 may comprise memory 301 storing various forms of applications, such as an operating system 303; one or more user applications 302, such as document applications, media applications, file and/or data access applications, communication applications such as web browsers and/or email clients, utilities, and/or games; and/or drivers for various peripherals. The client device 110 may comprise a variety of peripheral components, such as a wired and/or wireless network adapter 306 connectible to a local area network and/or wide area network; one or more output components, such as a display 308 coupled with a display adapter (optionally including a graphical processing unit (GPU)), a sound adapter coupled with a speaker, and/or a printer; input devices for receiving input from the user, such as a keyboard 311, a mouse, a microphone, a camera, and/or a touch-sensitive component of the display 308; and/or environmental sensors, such as a global positioning system (GPS) receiver 319 that detects the location, velocity, and/or acceleration of the client device 110, a compass, accelerometer, and/or gyroscope that detects a physical orientation of the client device 110. Other components that may optionally be included with the client device 110 (though not shown in the schematic architecture diagram 300 of FIG. 3) include one or more storage components, such as a hard disk drive, a solid-state storage device (SSD), a flash memory device, and/or a magnetic and/or optical disk reader; and/or a flash memory device that may store a basic input/output system (BIOS) routine that facilitates booting the client device 110 to a state of readiness; and a climate control unit that regulates climate properties, such as temperature, humidity, and airflow.

The client device 110 may comprise a mainboard featuring one or more communication buses 312 that interconnect the processor 310, the memory 301, and various peripherals, using a variety of bus technologies, such as a variant of a serial or parallel AT Attachment (ATA) bus protocol; the Uniform Serial Bus (USB) protocol; and/or the Small Computer System Interface (SCI) bus protocol. The client device 110 may comprise a dedicated and/or shared power supply 318 that supplies and/or regulates power for other components, and/or a battery 304 that stores power for use while the client device 110 is not connected to a power source via the power supply 318. The client device 110 may provide power to and/or receive power from other client devices.

In some scenarios, as a user 112 interacts with a software application on a client device 110 (e.g., an instant messenger and/or electronic mail application), descriptive content in the form of signals or stored physical states within memory (e.g., an email address, instant messenger identifier, phone number, postal address, message content, date, and/or time) may be identified. Descriptive content may be stored, typically along with contextual content. For example, the source of a phone number (e.g., a communication received from another user via an instant messenger application) may be stored as contextual content associated with the phone number. Contextual content, therefore, may identify circumstances surrounding receipt of a phone number (e.g., the date or time that the phone number was received), and may be associated with descriptive content. Contextual content, may, for example, be used to subsequently search for associated descriptive content. For example, a search for phone numbers received from specific individuals, received via an instant messenger application or at a given date or time, may be initiated. The client device 110 may include one or more servers that may locally serve the client device 110 and/or other client devices of the user 112 and/or other individuals. For example, a locally installed webserver may provide web content in response to locally submitted web requests. Many such client devices 110 may be configured and/or adapted to utilize at least a portion of the techniques presented herein.

2. Presented Techniques

One or more computing devices and/or techniques for presenting meeting options associated with trips are provided. For example, a user may access and/or interact with one or more services (e.g., a scheduling service such as a web-based calendar, an email service, an instant messaging service, a social network service, a hotel reservation service, a flight reservation service, etc.) for scheduling trips, disclosing travel plans to contacts, reserving flights to destinations and/or reserving hotels at destinations. In some examples, the one or more services may be accessed and/or interacted with via a first client device associated with a first user account of the user. For example, the user may plan a trip to a location using the one or more services. One or more contacts associated with the user and/or the first user account may be in an area associated with the location (e.g., the one or more contacts may reside within or near the location, the one or more contacts may be within or near the location during a time associated with the trip, etc.). However, the user may not know that the one or more contacts are in the area associated with the location during the time associated with the trip. Thus, the user may travel to the location and/or may not plan to meet with the one or more contacts.

In accordance with one or more of the techniques presented herein, the location and/or the time associated with the trip may be determined. A first location profile associated with the first user account may be generated based upon the location and/or the time. A plurality of user accounts having a relationship with the first user account may be determined. The plurality of user accounts may correspond to a plurality of contacts having a relationship with the user. A plurality of location profiles, associated with the plurality of user accounts, may be compared with the first location profile to determine that one or more location profiles comprise one or more locations and/or one or more times that match the location and/or the time associated with the trip. The one or more location profiles may correspond to one or more user accounts associated with the one or more contacts. A notification, indicative of the one or more locations and/or the one or more times matching the location and/or the time, may be transmitted to the first client device. The user may determine that the one or more contacts are in the area during the time based upon the notification. The user may schedule a meeting time and/or a meeting location to meet with a contact of the one or more contacts.

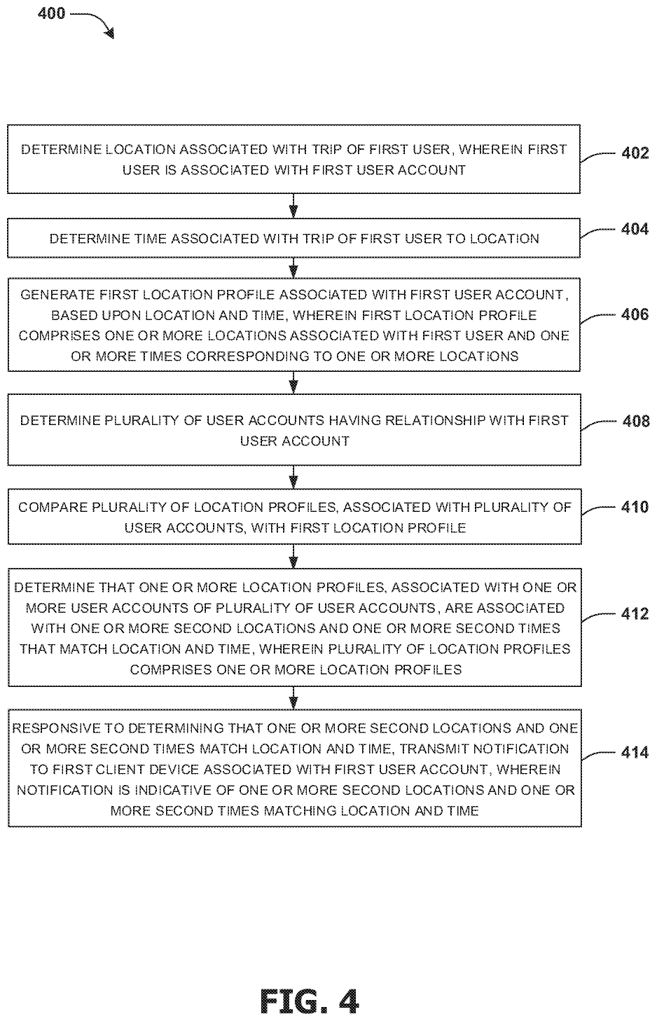

An embodiment of presenting meeting options associated with trips is illustrated by an example method 400 of FIG. 4. A user, such as user Jill, (e.g., and/or a first client device associated with the user) may access and/or interact with one or more services (e.g., a scheduling service such as a web-based calendar, an email service, an instant messaging service, a social network service, a hotel reservation service, a flight reservation service, a car rental service etc.) for scheduling trips, disclosing travel plans to contacts, reserving flights to destinations, reserving hotels at destinations, reserving rental cars at destinations, etc. In some examples, the one or more services may be accessed and/or interacted with via the first client device associated with the user.

At 402, a first location associated with a trip of the user may be determined. At 404, a first time associated with the trip of first user to the first location may be determined. In some examples, the trip of the user to the first location may comprise an instance that the user travels to the first location for work, leisure, recreation, tourism, research, a pilgrimage, etc. and/or stays at the first location temporarily. Alternatively and/or additionally, the trip of the user may comprise an instance that the user travels to the first location to live at the first location and/or near the first location for an undetermined amount of time and/or a determined amount of time (e.g., one or more weeks, one or more months, one or more years, etc.).

For example, the user may schedule the trip to the first location using the one or more services (e.g., using a scheduling service such as a web-based calendar associated with the user account). The first location may be different than a city of residence associated with the user, a country different than a country of residence associated with the user, etc. Alternatively and/or additionally, the trip to the first location may be disclosed to one or more contacts using the one or more services (e.g., information associated with the trip may be shared via email, instant messaging, a social network platform, etc.). Alternatively and/or additionally, one or more transportation reservations (e.g., train reservations, bus reservations, airplane reservations, etc.) may be made for transportation to the first location and/or transportation from the first location (e.g., to the city of residence of the user). For example, one or more flights associated with the trip may be reserved using the one or more services. Alternatively and/or additionally, a lodging accommodation (e.g., a hotel) may be reserved using the one or more services.

For example, the first location and/or the first time may be determined by monitoring the web-based calendar associated with the user account. For example, an indication of time (e.g., an indication of a starting time and/or an end time corresponding to the first time associated with the trip) may be entered into the web-based calendar (e.g., by the user). Alternatively and/or additionally, an indication of location may be entered into the web-based calendar. Responsive to the indication of time and/or the indication of location being entered into the web-based calendar, the first time and/or the first location may be determined.

In an example, a calendar event comprising the indication of time and/or the indication of location may be entered into the web-based calendar. The indication of time may comprise “09/23/2018-09/29/2018” and/or the indication of location may comprise “CSI fundraising event in Miami”. The first time may be determined to be “09/23/2018-09/29/2018” based upon the indication of time.

For example, the starting time may be determined to be “09/23/2018” based upon the indication of time and/or the end time may be determined to be “09/29/2018” based upon the indication of time. Alternatively and/or additionally, the first location may be determined to be “Miami, Fla.” based upon “Miami” and/or a determination that a CSI fundraising event is held in Miami, Fla. Alternatively and/or additionally, the first location may be determined to be “Expedition Plaza Building, Sinclair Blvd, Miami, Fla.” based upon a determination that the CSI fundraising event is held in a building named “Expedition Plaza Building” located on a street named “Sinclair Blvd”.

Alternatively and/or additionally, the first time may be determined based upon the indication of the first location. For example, the first time may be determined to be “09/23/2018-09/29/2018” based upon a determination that the CSI fundraising event starts on “09/23/2018” and/or a determination that the CSI fundraising event ends on “09/29/2018”.

Alternatively and/or additionally, the first location and/or the first time may be determined by monitoring email messages associated with the first user account. For example, an indication of time (e.g., an indication of the starting time and/or the end time corresponding to the first time associated with the trip) may be received by an email account (e.g., associated with the first user account) and/or transmitted by the email account (e.g., to one or more other email accounts). Alternatively and/or additionally, an indication of location may be received by the email account and/or transmitted by the email account.

In a first example, a lodging reservation (e.g., a hotel room reservation and/or a reservation for a different type of lodging accommodation) may be made (e.g., by phone, using a hotel reservation website, etc.). A first email message comprising information associated with the lodging reservation (e.g., a receipt, a voucher, etc.) may be received by the email account. The first email message may comprise the indication of time (e.g., “09/23/2018-09/29/2018”) and/or the indication of location (e.g., “Best Hotel, Miami, Fla.”). The starting time (e.g., of the first time associated with the trip) may be determined to be “09/23/2018” and/or the end time may be determined to be “09/29/2018” based upon the indication of time. Alternatively and/or additionally, the first location may be determined to be “Miami, Fla.” and/or “Best Hotel, Beach Front Street, Miami, Fla.”, based upon the indication of location.

In a second example, one or more transportation reservations (e.g., one or more train reservations, one or more bus reservations, one or more flight reservations, etc.) may be made (e.g., by phone, using a transportation reservation website, etc.). For example, a first transportation reservation may be reserved for transportation from the city of residence of the user (e.g., and/or a different city) to the first location. Alternatively and/or additionally, a second transportation reservation may be reserved for transportation from the first location to the city of residence of the user (e.g., and/or a different city). A second email message comprising information associated with the first transportation reservation (e.g., a receipt, flight information, etc.) may be received by the email account. Alternatively and/or additionally, a third email message comprising information associated with the second transportation reservation may be received by the email account. The second email message may comprise a first indication of time (e.g., “Arrival: 3:40 PM 09/23/2018”) associated with an arrival time of the first transportation reservation and/or the third email message may comprise a second indication of time (e.g., “Departure: 8:05 PM 09/29/2018”) associated with a departure time of the second transportation reservation. The starting time (e.g., of the first time associated with the trip) may be determined to be “3:40 PM 09/23/2018” based upon the first indication of time and/or the end time may be determined to be “8:05 PM 09/29/2018” based upon the second indication of time. Alternatively and/or additionally, the second email message and/or the third email message may comprise the indication of location (e.g., Miami, Fla.). The first location may be determined to be “Miami, Fla.” based upon the indication of location.

In a third example, a fourth email message may be transmitted to one or more email accounts associated with one or more contacts of the first user account. For example, information of the trip may be disclosed to the one or more contacts using the fourth email message. For example, the fourth email message may comprise “Hey John, I'm going to Miami on Sunday, the 23^{rd} of August for the CSI fundraising event and I'm coming back on the 29th. We should meet afterwards”. The starting time, the end time and/or the first location of the trip may be determined based upon the fourth email message.

In a fourth example, a fifth email message may be received by the email account from a second email account associated with a contact of the first user account. For example, information of the trip may be comprised within the fifth email message. For example, the fifth email message may comprise “Hey Adam, I heard you're going to the CSI fundraising event from August 23^{rd} to August 29^{th}. Have a good time”. The starting time, the end time and/or the first location of the trip may be determined based upon the fifth email message and/or a determination that the CSI fundraising event is held in Miami, Fla.

In a fifth example, a rental car may be reserved (e.g., by phone, using a car rental website, etc.). A sixth email message comprising information associated with a reservation of the rental car may be received by the email account. The starting time, the end time and/or the first location of the trip may be determined based upon the sixth email message.

Alternatively and/or additionally, the first location and/or the first time may be determined by monitoring messages other than email messages (e.g., instant messages, text messages, etc.) associated with the first user account. For example, an indication of time (e.g., an indication of the starting time and/or the end time corresponding to the first time associated with the trip) may be received by a messaging account (e.g., an instant messaging account associated with the first user account) and/or transmitted by the messaging account (e.g., to one or more other messaging accounts). Alternatively and/or additionally, an indication of location may be received by the messaging account and/or transmitted by the messaging account.

Alternatively and/or additionally, the first location and/or the first time may be determined by monitoring social network activity associated with the first user account. For example, an indication of time (e.g., an indication of the starting time and/or the end time corresponding to the first time associated with the trip) and/or an indication of location may be comprised within a social network message associated with a social network account associated with the first user account. For example, the social network message may be posted publicly. Alternatively and/or additionally, the social network message may be transmitted to one or more social network accounts associated with one or more contacts associated with the first user account. Alternatively and/or additionally, the social network message may be received from a second social network account associated with a contact of the user. The first location and/or the first time may be determined based upon the social network message.

Alternatively and/or additionally, a social network post comprising an indication of time and/or an indication of location may be entered into a social network platform. For example, the social network post may be available to view publicly on the social network platform. Alternatively and/or additionally, the social network post may be available to view only by contacts associated with the first user account and/or selected contacts associated with the first user account. The first location and/or the first time may be determined based upon the social network post.

At 406, a first location profile associated with the first user account may be generated based upon the first location and the first time. The first location profile may comprise one or more locations associated with the first user and/or one or more times corresponding to the one or more locations. For example, at least a portion of the one or more locations may correspond to one or more trips of the user. In some examples, the generating the first location profile may comprise modifying and/or updating an existing location profile associated with the user based upon the first location and/or the first time associated with the trip.

In an example, the one or more locations may comprise the first location associated with the trip and/or the one or more times may comprise the first time associated with the first location. Alternatively and/or additionally, the one or more locations may comprise a second location associated with a second trip and/or a second time associated with the second location and/or the second trip. Alternatively and/or additionally, the one or more locations may comprise a third location associated with the city of residence of the user and/or a third time associated with the third location.

At 408, a plurality of user accounts having a relationship with the first user account may be determined. For example, the plurality of user accounts may be associated with a plurality of contacts of the user. For example, first information associated with first contacts of the plurality of contacts may be stored in one or more first contact lists (e.g., one or more address books) of the first client device and/or one or more other client devices associated with the user (e.g., phone numbers, email accounts, addresses, etc. associated with the first contacts may be stored on the first client device and/or the one or more other client devices). Alternatively and/or additionally, second information associated with second contacts of the plurality of contacts may be stored in one or more second contact lists (e.g., an address book) associated with the email account, the messaging account associated with the first user account and/or a different communication account associated with a communication application.

Alternatively and/or additionally, the plurality of contacts may be identified based upon connection information associated with the social network account. For example, third contacts of the plurality of contacts may be associated with social network accounts that have a connection with the social network account. For example, the social network accounts may be friends, connections, etc. with the social network account. The plurality of contacts may be identified based upon the first information (associated with the first contacts), the second information (associated with the second contacts) and/or the connection information (associated with the third contacts).

In some examples, the one or more first contact lists (e.g., of the first client device and/or the one or more other client devices) may be analyzed to determine the first information associated with the first contacts. The first information may be compared with the second information (within the one or more second contact lists) and/or the connection information to identify information associated with the first contacts that is not included in the one or more first contact lists. For example, the first information may be compared with the second information and/or the connection information to identify usernames associated with the first contacts and/or other information (e.g., relationship levels of the first contacts with the first user account, amounts of communication between the first contacts and the first user account, workplace information associated with the first contacts, etc.) that are not included in the one or more first contact lists.

Alternatively and/or additionally, the one or more second contact lists may be analyzed to determine the second information associated with the second contacts. The second information may be compared with the first information (within the one or more first contact lists) and/or the connection information to identify information associated with the second contacts that is not included in the one or more second contact lists. For example, the second information may be compared with the first information and/or the connection information to identify usernames associated with the second contacts and/or other information (e.g., relationship levels of the second contacts with the first user account, amounts of communication between the second contacts and the first user account, workplace information associated with the second contacts, etc.) that are not included in the second contact list.

Alternatively and/or additionally, the connection information (associated with the social network account of the user) may be compared with the first information (within the one or more first contact lists) and/or the second information (within the one or more second contact lists) to identify information associated with the third contacts that is not included in the connection information. For example, the connection information may be compared with the first information and/or the second information to identify usernames associated with the third contacts and/or other information (e.g., relationship levels of the third contacts with the first user account, amounts of communication between the third contacts and the first user account, workplace information associated with the third contacts, etc.) that are not included in the connection information.

In some examples, a plurality of weights may be assigned to a second plurality of user accounts comprising the plurality of user accounts. Each weight of the plurality of weights may be assigned to a user account of the second plurality of user accounts. For example, user accounts of the second plurality of user accounts may be selected for inclusion in the plurality of user accounts based upon a determination that each weight of a second plurality of weights assigned to the user accounts is higher than a weight threshold.

In some examples, each weight of the plurality of weights may be assigned to a user account of the second plurality of user accounts based upon an amount of communication between the first user account and the user account. For example, the amount of communication may be determined based upon a number of communications (e.g., email messages, messages, phone calls, calls using a communication app, video calls, etc.) between the first user account and a user account. Alternatively and/or additionally, the amount of communication may be determined based upon a frequency of communications (e.g., a number of communications per day, a number of communications per week, etc.) between the first user account and a user account. Alternatively and/or additionally, the amount of communication may be determined based upon lengths of communications (e.g., number of characters in email messages and/or messages, lengths of time associated with phone calls, calls using the communication app and/or video calls, etc.) between the first user account and a user account.

For example, a second user account associated with a second contact of the first user account may have a first amount of communication with the first user account. Alternatively and/or additionally, a third user account associated with a third contact of the first user account may have a second amount of communication with the first user account. In some examples, the first amount of communication may be greater than the second amount of communication. Accordingly, a first weight assigned to the second user account may be higher than a second weight assigned to the third user account. In some examples, the first weight may be higher than the weight threshold and/or the second weight may be lower than the weight threshold. Accordingly, the second user account may be selected for inclusion in the plurality of user accounts and/or the third user account may not be selected for inclusion in the plurality of user accounts.

In some examples, merely a portion of the second plurality of user accounts (e.g., top 10 user accounts, top 50 user accounts, etc.) may be selected for inclusion in the plurality of user accounts. For example, the weight threshold may be determined based upon the plurality of weights. For example, in an instance where a defined number of user accounts (e.g., 10 user accounts, 50 user accounts, etc.) may be included in the plurality of user accounts, the weight threshold may be defined such that the second plurality of weights of the plurality of user accounts may be higher than the weight threshold and/or such that the plurality of user accounts comprises the defined number of user accounts.

Alternatively and/or additionally, the plurality of weights may be assigned to the second plurality of user accounts based upon relationships of the second plurality of user accounts with the user account. For example, it may be determined that relationships of the plurality of user accounts with the user account may be associated with relationship levels (e.g., a first level indicating a strong relationship, a second level indicating an average relationship, a third level indicating a weak relationship, etc.) that are higher than a relationship level threshold. Alternatively and/or additionally, one or more inputs comprising indications of the relationship levels may be received. For example, the relationship levels may be determined based upon the one or more inputs.

At 410, a plurality of location profiles, associated with the plurality of user accounts, may be compared with the first location profile. For example, locations and/or times comprised within each location profile of the plurality of location profiles may be compared with the first location and/or the first time of the first location profile. At 412, one or more location profiles, associated with one or more user accounts of the plurality of user accounts, that are associated with one or more second locations and/or one or more second times that match the first location and/or the first time may be determined. For example, the one or more location profiles, associated with one or more contacts of the user, may be comprised within the plurality of location profiles.

In a first example, the one or more location profiles may comprise a second location profile associated with a fourth user account. For example, the fourth user account may be associated with a fourth contact of the user. The second location profile may comprise an indication that the fourth contact is scheduled to be at a third location during a third time. For example, the second location profile may comprise an indication that the fourth contact is in Miami, Fla. from 09/20/2018 to 09/25/2018 (e.g., the fourth contact may be on a trip to Miami, Fla. during the third time). Accordingly, the third location may be determined to be Miami, Fla. and/or the third time may be determined to be 09/20/2018 to 09/25/2018. It may be determined that the third location matches the first location (e.g., of the first location profile associated with the first user account) based upon a comparison of the first location with the third location. Alternatively and/or additionally, it may be determined that the third time matches the first time based upon a determination that the third time coincides with the first time.

In a second example, the one or more location profiles may comprise a third location profile associated with a fifth user account. For example, the fifth user account may be associated with a fifth contact of the user. The third location profile may comprise an indication that the fifth contact is scheduled to be at a fourth location during the first time. For example, the third location profile may comprise an indication that the fifth contact resides in Westchester, Fla. and/or that the fifth contact is not scheduled to be on a trip (to a different location) during the first time. It may be determined that the fourth location matches the first location based upon a determination that Westchester, Fla. is within a threshold distance (e.g., five miles, 10 miles, 30 miles, etc.) from the first location (e.g., Miami, Fla.).

At 414, responsive to determining that the one or more second locations and/or the one or more second times (of the one or more location profiles) match the first location and/or the first time, a notification may be transmitted to the first client device associated with the first user account. The notification may be indicative of the one or more second locations and/or the one or more second times matching the first location and/or the first time.

For example, the notification may be comprised within a seventh email message transmitted to the email account associated with the first user account. Alternatively and/or additionally, the notification may be comprised within a message that is not an email message (e.g., a text message, an instant message, etc.) transmitted to the messaging account associated with the first user account. Alternatively and/or additionally, the notification may comprise a push notification transmitted to the first client device. Alternatively and/or additionally, the notification may comprise a social network notification that may be presented responsive to the first client device accessing a social network interface.

In some examples, the notification may comprise an indication that the one or more contacts (associated with the one or more user accounts) are likely to be within a threshold distance from the first location during the first time (of the trip). Alternatively and/or additionally, the notification may comprise one or more first selectable inputs corresponding to scheduling a meeting with the one or more contacts. For example, the notification may comprise a first selectable input corresponding to scheduling a meeting with the fourth contact (of the one or more contacts). Alternatively and/or additionally, the notification may comprise a second selectable input corresponding to scheduling a meeting with the fifth contact (of the one or more contacts). For example, responsive to receiving a selection of the first selectable input, a second notification may be transmitted to a second client device of the fourth contact comprising an indication that the user associated with the first user account is at the first location during the first time and/or that the user requests a meeting with the fourth contact during the first time.

Alternatively and/or additionally, one or more first times that the fourth contact is available may be determined. For example, the one or more first times may be determined based upon a work schedule associated with the fourth contact, a second web-based calendar associated with the fourth contact, etc. A graphical user interface of the first client device may be controlled to display one or more indications of the one or more first times that the fourth contact is available. For example, the one or more indications of the one or more first times may be comprised within the notification. Alternatively and/or additionally, the one or more indications of the one or more first times may not be comprised within the notification.

In some examples, the graphical user interface of the first client device may be controlled to display one or more second selectable inputs associated with the one or more first times. For example, the one or more second selectable inputs may comprise a third selectable input corresponding to a fourth time of the one or more first times, a fourth selectable input corresponding to a fifth time of the one or more first times, etc. Responsive to receiving a selection of the third selectable input, a third notification may be transmitted to the second client device of the fourth contact comprising an indication that the user requests a meeting with the fourth contact at the fourth time. Alternatively and/or additionally, responsive to receiving an input associated with a sixth time different than the one or more first times, a fourth notification may be transmitted to the second client device of the fourth contact comprising an indication that the user requests a meeting with the fourth contact at the sixth time.

Alternatively and/or additionally, one or more hotels associated with the one or more second locations of the one or more user accounts may be determined. For example, the one or more hotels may be determined based upon the one or more second locations such that a hotel of the one or more hotels is within a threshold distance from a location of the one or more locations. Alternatively and/or additionally, the one or more hotels may be determined based upon one or more workplace locations of the one or more contacts (e.g., one or more locations determined to be where the one or more contacts work) such that a hotel of the one or more hotels is within a threshold distance from a workplace location of the one or more workplace locations. Alternatively and/or additionally, the one or more hotels may be determined based upon one or more locations of residence of the one or more contacts (e.g., one or more locations determined to be where the one or more contacts reside, such as a home, a hotel, etc.) such that a hotel of the one or more hotels is within a threshold distance from a location of residence of the one or more locations of residence.

In some examples, the graphical user interface of the first client device may be controlled to display one or more third selectable inputs associated with the one or more hotels. Alternatively and/or additionally, the graphical user interface of the first client device may be controlled to display location information of the one or more hotels. The location information of the one or hotels may comprise an indication of a distance from each hotel to a location associated with a contact of the one or more contacts.

In a first example, the location information may comprise an indication that a first hotel of the one or more hotels is a first distance from a second hotel that the fourth contact reserved. The one or more third selectable inputs may comprise a fifth selectable input corresponding to reserving a lodging accommodation (e.g., a hotel room) at the first hotel. For example, responsive to receiving a selection of the fifth selectable input, a first hotel reservation interface associated with the first hotel may be displayed. In a second example, the location information may comprise an indication that a second hotel of the one or more hotels is a second distance from a home of the fifth contact. The one or more third selectable inputs may comprise a sixth selectable input corresponding to reserving a lodging accommodation at the second hotel. For example, responsive to receiving a selection of the sixth selectable input, a second hotel reservation interface associated with the second hotel may be displayed. In a third example, the location information may comprise an indication that a third hotel of the one or more hotels is a third distance away from a workplace of the fifth contact. The one or more third selectable inputs may comprise a seventh selectable input corresponding to reserving a lodging accommodation at the third hotel. For example, responsive to receiving a selection of the seventh selectable input, a third hotel reservation interface associated with the third hotel may be displayed.

Alternatively and/or additionally, one or more destination locations associated with the first location may be determined. For example, the one or more destination locations may be associated with the first location and/or the one or more second locations of the one or more contacts. The one or more destination locations may comprise one or more restaurants, one or more tourist attractions, one or more cafes, one or more landmarks, etc. that the user may have an interest in visiting with a contact of the one or more contacts and/or without a contact of the one or more contacts. For example, the one or more destination locations may be determined based upon past user activity associated with the user (e.g., the one or more destination locations may be determined based upon restaurant reviews associated with the user, types of food that the user has expressed an interest in using email messages, social network activity, etc., types of tourist attractions and/or landmarks that the user has expressed an interest in using email messages, social network activity, etc.). Alternatively and/or additionally, the one or more destination locations may be determined based upon popularities of destination locations associated with the first location.

For example, the one or more destination locations may be determined based upon the one or more second locations such that a destination location of the one or more destination locations is within a threshold distance from a location of the one or more second locations. Alternatively and/or additionally, the one or more destination locations may be determined based upon the first location such that a destination location of the one or more destination locations is within a threshold distance from the first location. Alternatively and/or additionally, the one or more destination locations may be determined based upon the one or more workplace locations such that a destination location of the one or more destination locations is within a threshold distance from a workplace location of the one or more workplace locations. Alternatively and/or additionally, the one or more destination locations may be determined based upon the one or more locations of residence such that a destination location of the one or more destination locations is within a threshold distance from a location of residence of the one or more locations of residence.

In some examples, the graphical user interface of the first client device may be controlled to display one or more fourth selectable inputs associated with the one or more destination locations and/or the one or more contacts. Alternatively and/or additionally, the graphical user interface of the first client device may be controlled to display destination information of the one or more destination locations. The destination information may comprise an indication of a distance from each destination location to a location associated with a contact of the one or more contacts.

In an example, the destination information may comprise an indication that a first destination location of the one or more destination locations is a fourth distance away from the second hotel that the fourth contact reserved. The one or more fourth selectable inputs may comprise an eighth selectable input corresponding to scheduling a meeting with the fourth contact at the first destination location. Alternatively and/or additionally, the one or more fourth selectable inputs may comprise a ninth selectable input corresponding to scheduling a meeting with the fifth contact at the first destination location. In some examples, responsive to receiving a selection of the eighth selectable input, a fourth notification may be transmitted to the second client device of the fourth contact comprising an indication that the user requests a meeting with the fourth contact at the first destination location.

In some examples, one or more items (e.g., clothing options, accessories, etc.) associated with one or more determined weather conditions of the first location during the first time may be determined. For example, the one or more items may be determined based upon one or more temperatures of the first location during the first time, one or more levels of sunshine of the first location during the first time and/or one or more different weather conditions. For example, responsive to determining that a temperature of the first location is forecasted to be higher than 70 degrees Fahrenheit during the first time, the one or more items may comprise a T-shirt, a short-sleeve shirt, a pair of shorts, etc. Alternatively and/or additionally, responsive to determining that the temperature of the first location is forecasted to be lower than 60 degrees Fahrenheit during the first time, the one or more items may comprise a jacket, a long-sleeve shirt, a pair of jeans, etc. Alternatively and/or additionally, responsive to determining that a level of sunshine of the first location is forecasted to be higher than a threshold level of sunshine, the one or more items may comprise a bottle of sunscreen, a visor, etc. Alternatively and/or additionally, responsive to determining that it is forecasted that it will be raining at the first location during the first time, the one or more items may comprise an umbrella, a raincoat, etc. In some examples, the one or more items may comprise items unrelated to the weather conditions of the first location. For example, the one or more items may comprise items that may be determined to be useful for the trip (e.g., a laptop if the trip is longer than a threshold number of days and/or if the trip is for business, a toothbrush, a phone charger, etc.).

The graphical user interface of the first client device may be controlled to display one or more indications of the one or more items. For example, the one or more indications of the one or more items may be comprised within the notification. Alternatively and/or additionally, the one or more indications of the one or more items may not be comprised within the notification. For example, the one or more indications of the one or more items may be comprised within a fifth notification transmitted to the first client device before the first time of the trip (e.g., 8 hours before the first time, 1 day before the first time, 3 days before the first time, etc.).

In some examples, the graphical user interface of the first client device may be controlled to display one or more fifth selectable inputs associated with the one or more items (e.g., the one or more fifth selectable inputs may be comprised within the fifth notification). For example, the one or more fifth selectable inputs may correspond to purchasing products associated with the one or more items. In an example, a first item of the one or more items may not be available to the user to take on the trip. The one or more fifth selectable inputs may comprise a tenth selectable input corresponding to purchasing a product associated with the first item. For example, responsive to receiving a selection of the tenth selectable input, a purchasing interface associated with the first item may be displayed and/or a product associated with the first item may be purchased.

In some examples, the graphical user interface of the first client device may be controlled to display one or more sixth selectable inputs corresponding to communicating with the one or more contacts. For example, the one or more sixth selectable inputs may comprise an eleventh selectable input corresponding to communicating with the fourth contact. Alternatively and/or additionally, the one or more sixth selectable inputs may comprise a twelfth selectable input corresponding to communicating with the fifth contact. For example, responsive to receiving a selection of the eleventh selectable input, a messaging interface (e.g., associated with the email account, the messaging account, etc.) may be presented such that a message may be inputted and/or transmitted to the second client device associated with the fourth contact.

In some examples, before transmitting the notification to the first client device, a sixth notification may be transmitted to the first client device. For example, the sixth notification may comprise an indication that the one or more contacts may be at the first location and/or within a threshold distance from the first location during the first time without comprising one or more user identifications associated with the one or more contacts (e.g., such that privacy of the one or more contacts is not violated). Rather than comprising the one or more user identifications, the sixth notification may merely comprise relationship information associated with the one or more contacts. For example, the relationship information may comprise one or more indications of one or more types of relationship between the user and the one or more contacts. For example, a first type of relationship may be “business relationship”. A second type of relationship may be “social relationship. A third type of relationship may be “coworker”. In an example, the sixth notification may comprise “You have two contacts around Miami during your trip. You have a social relationship with one of the contacts. You have a business relationship with one of the contacts”.

The graphical user interface of the first client device may be controlled to display one or more sixth selectable inputs associated with requesting permission from the one or more contacts to disclose the one or more identifications associated with the one or more contacts. For example, the one or more sixth selectable inputs may comprise a thirteenth selectable input corresponding to transmitting one or more requests to one or more client devices associated with the one or more contacts. Alternatively and/or additionally, the one or more sixth selectable inputs may comprise a fourteenth selectable input corresponding to transmitting one or more requests to one or more client devices associated with a set of contacts of the one or more contacts having the first type of relationship with the user (e.g., the fourteenth selectable input may comprise an indication comprising “Send request to contacts that you have a business relationship with so that you can identify them and connect with them on your trip”).

Alternatively and/or additionally, the one or more sixth selectable inputs may comprise a fifteenth selectable input corresponding to transmitting one or more requests to one or more client devices associated with a set of contacts of the one or more contacts having the second type of relationship with the user (e.g., the fifteenth selectable input may comprise an indication comprising “Send request to contacts that you have a social relationship with so that you can identify them and connect with them on your trip”). Alternatively and/or additionally, the one or more sixth selectable inputs may comprise a sixteenth selectable input corresponding to transmitting one or more requests to one or more client devices associated with a set of contacts of the one or more contacts having the third type of relationship with the user (e.g., the sixteenth selectable input may comprise an indication comprising “Send request to contacts that you've worked with so that you can identify them and connect with them on your trip”).

For example, responsive to receiving a selection of the thirteenth selectable input, one or more notifications may be transmitted to the one or more client devices associated with the one or more contacts. The one or more notifications may comprise an indication of a user identification of the user, an indication of the first location and/or an indication of the first time. Each notification of the one or more notifications may comprise a seventeenth selectable input corresponding to granting permission to disclose a user identification (associated with a contact corresponding to the notification).

In an example, a seventh notification of the one or more notifications may be transmitted to the second client device of the fourth contact. The seventh notification may comprise “A contact that has a business relationship with you will be in Miami, Fla. from August 23^{rd} to August 29^{th}. Would you like to disclose to him that you'll be there as well?”. The seventh notification may comprise the seventeenth selectable input. Responsive to receiving a selection of the seventeenth selectable input from the second client device, the notification, comprising a first user identification associated with the fourth contact, may be transmitted to the first client device.

Alternatively and/or additionally, before transmitting the notification to the first client device (and/or disclosing to the user that the one or more second locations and/or the one or more second times of the one or more contacts match the first location and/or the first time of the trip), one or more second notifications may be transmitted to the one or more client devices associated with the one or more contacts. The one or more second notifications may be associated with requesting permission to disclose that the one or more second locations and/or the one or more second times of the one or more contacts match the first location and/or the first time of the user. In some examples, the one or more second notifications may not comprise an indication of a second user identification associated with the user. For example, rather than the one or more second notifications comprising an indication of the second user identification, the one or more second notifications may comprise merely relationship information associated with the one or more contacts. In some examples, each notification of the one or more second notifications may comprise an eighteenth selectable input corresponding to granting permission to disclose a user identification of a contact.

In an example, an eighth notification of the one or more second notifications may be transmitted to the second client device of the fourth contact. The eighth notification may comprise “A contact that has a business relationship with you will be in Miami, Fla. from August 23^{rd} to August 29^{th}. Would you like to disclose to him that you'll be there as well?”. The eighth notification may comprise the eighteenth selectable input. Responsive to receiving a selection of the eighteenth selectable input from the second client device, the notification, comprising the first user identification associated with the fourth contact, may be transmitted to the first client device.

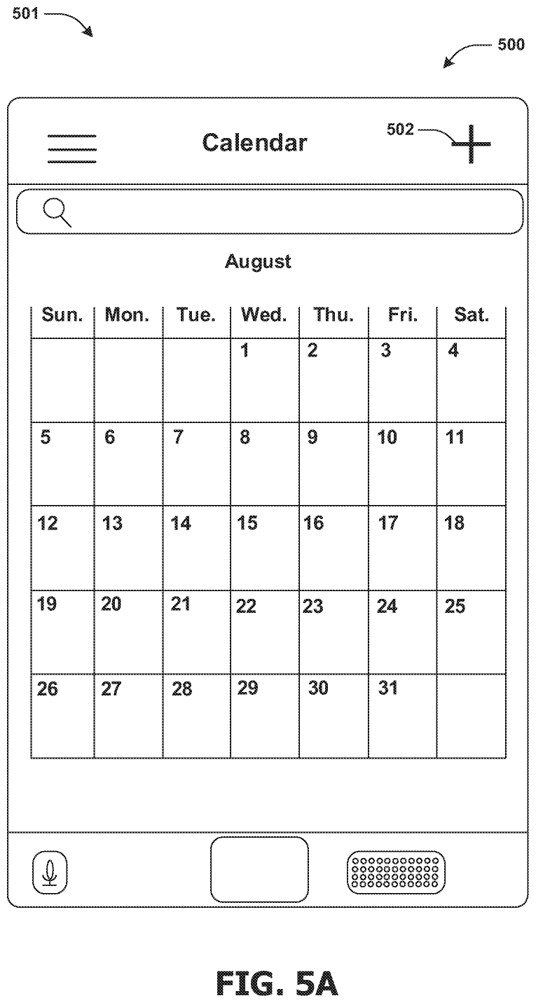

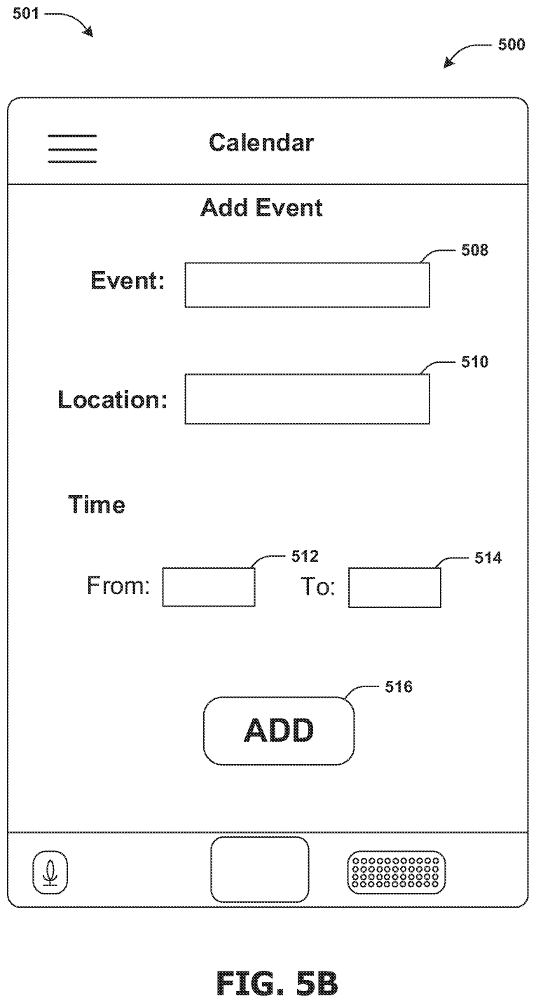

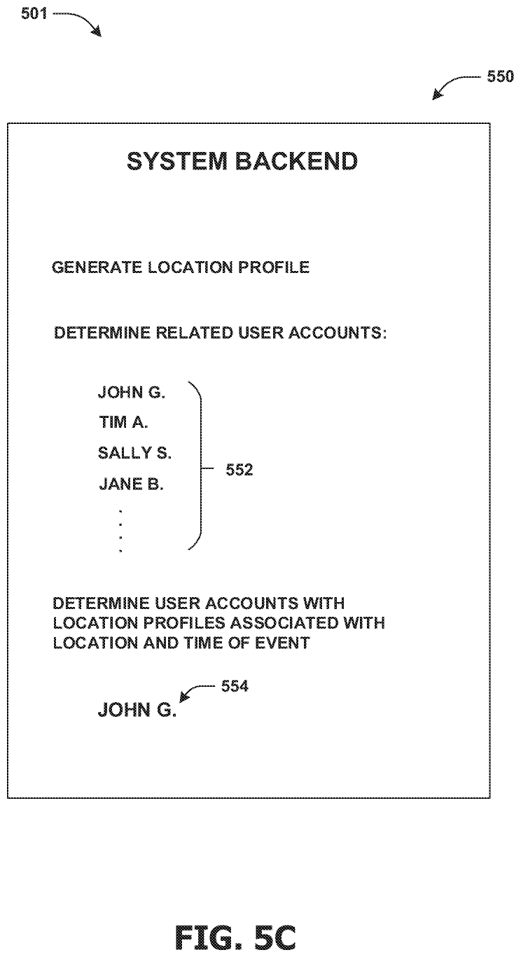

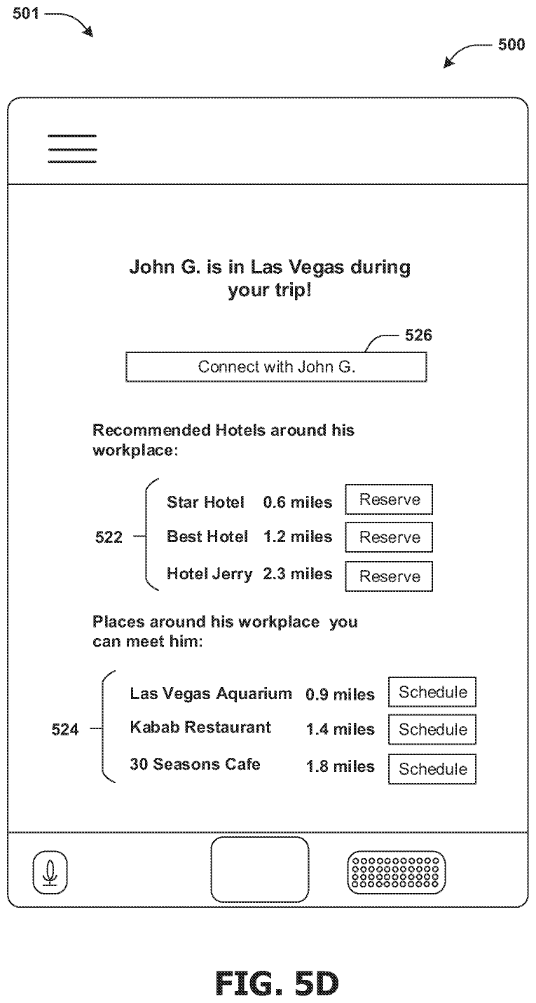

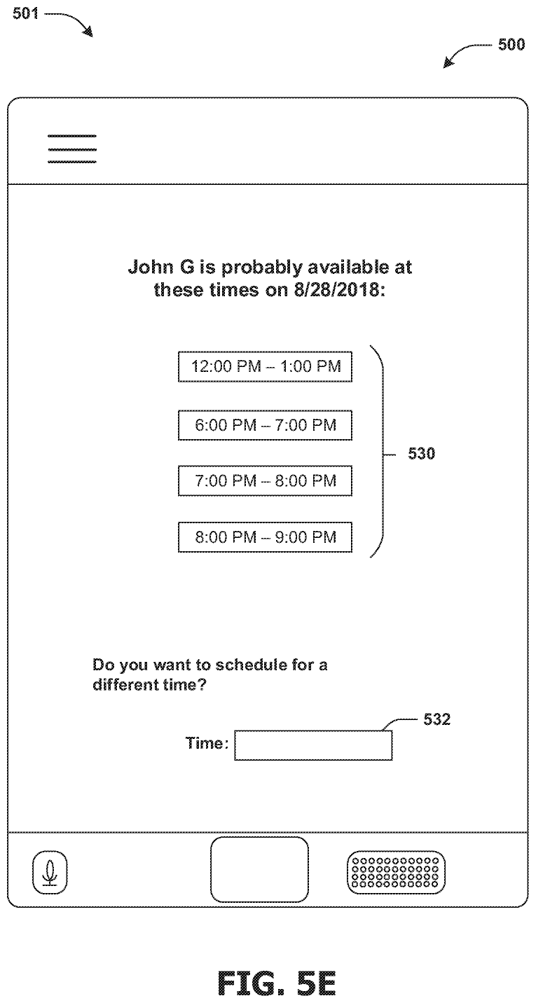

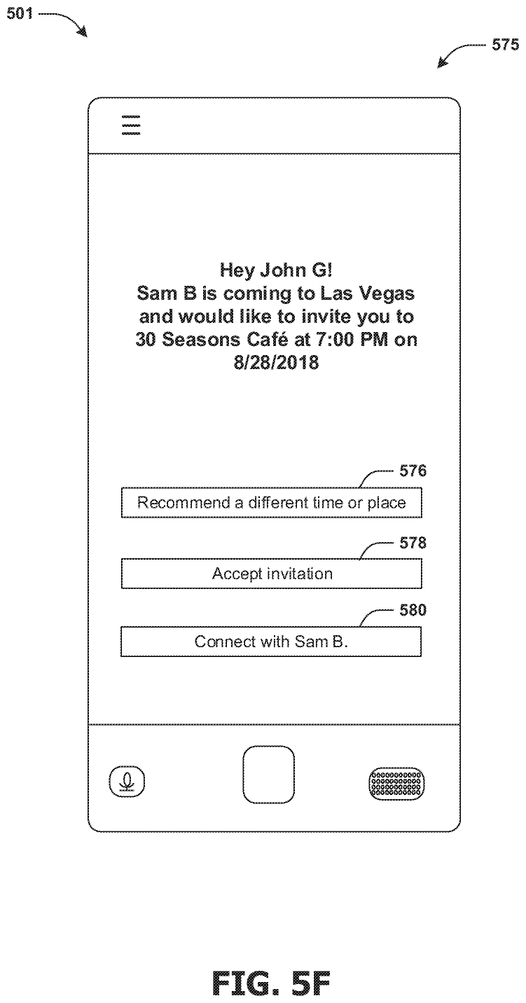

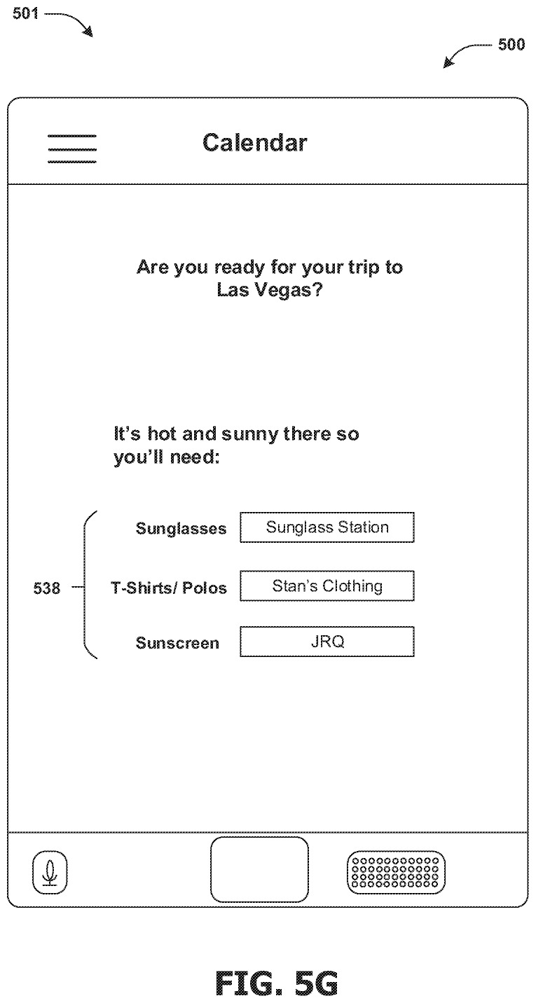

FIGS. 5A-5G illustrate examples of a system 501 for presenting meeting options associated with a trip. A user, such as user Jack, (e.g., and/or a first client device 500 associated with the user) may access and/or interact with one or more services for scheduling trips, disclosing travel plans to contacts, reserving flights to destinations, reserving hotels at destinations, etc. using the first client device 500.

FIG. 5A illustrates a graphical user interface of the first client device 500 being controlled to display a calendar interface associated with a web-based calendar. For example, the calendar interface may comprise a first selectable input 502 corresponding to entering a calendar event into the web-based calendar. For example, a selection of the first selectable input 502 may be received via the calendar interface.

FIG. 5B illustrates the calendar interface displaying a plurality of selectable inputs associated with a calendar event. For example, the calendar event may be associated with a trip of the user. A description of the trip may be entered via a second selectable input 508 of the plurality of selectable inputs. For example, the description of the trip may comprise “Vacation”. Alternatively and/or additionally, a location of the trip may be entered via a third selectable input 510 of the plurality of selectable inputs. For example, the location of the trip may comprise “Las Vegas, Nevada”. Alternatively and/or additionally, a time of the trip may be entered via a fourth selectable input 512 and/or a fifth selectable input 514 of the plurality of selectable inputs. For example, a starting time of the trip may be entered via the fourth selectable input 512. The starting time may comprise “8/23/2018”. Alternatively and/or additionally, an end time of the trip may be entered via the fifth selectable input 514. The end time may comprise “9/1/2018”. The description of the trip, the location of the trip and/or the time of the trip may be entered into the web-based calendar using a sixth selectable input 516 “ADD” of the plurality of selectable inputs.

FIG. 5C illustrates a backend system 550 generating a first location profile associated with a first user account of the user and/or comparing the first location profile with a plurality of location profiles. For example, the first location profile may be generated (by the backend system 550) based upon the time of the trip (e.g., the starting time and/or the end time) and/or the location of the trip. The first location profile may comprise one or more locations associated with the first user and/or one or more times corresponding to the one or more locations. In some examples, the generating the first location profile may comprise modifying and/or updating an existing location profile associated with the user based upon the location and/or the time associated with the trip.

In some examples, a plurality of user accounts 552 having a relationship with the first user account may be determined. For example, the plurality of user accounts 552 may be associated with a plurality of contacts of the first user account. A plurality of location profiles, associated with the plurality of user accounts 552, may be compared with the first location profile. For example, locations and/or times comprised within each location profile of the plurality of location profiles may be compared with the location and/or the time of the location profile. It may be determined that a second location profile, associated with a second user account 554, comprises a second location and/or a second time matching the location and/or the time (of the trip of the user). In some examples, responsive to determining that the second location and/or the second time associated with the second user account match the location and/or the time of the trip of the user, a notification may be transmitted to the first client device 500.

FIG. 5D illustrates the graphical user interface of the first client device 500 being controlled to display the notification indicative of the second location and/or the second time matching the location and/or the time of the trip of the user. For example, the notification may comprise a seventh selectable input 526 “Connect with John G.” corresponding to communicating with a contact associated with the second user account. For example, responsive to receiving a selection of the seventh selectable input 526, a messaging interface may be presented such that a message may be inputted and/or transmitted to a second client device 575 associated with the contact.

In some examples, a plurality of hotels 522 associated with a workplace location of the contact may be determined such that each hotel of the plurality of hotels 522 is within a threshold distance from the workplace location of the contact. For example, the graphical user interface of the first client device 500 may be controlled to display indications of the plurality of hotels 522. Alternatively and/or additionally, a first plurality of distances may be determined. Each distance of the first plurality of distances may correspond to a distance between the workplace location and a hotel of the plurality of hotels 522. For example, the graphical user interface of the first client device 500 may be controlled to display indications of the first plurality of distances.

Alternatively and/or additionally, the graphical user interface of the first client device 500 may be controlled to display a second plurality of selectable inputs associated with the plurality of hotels 522. For example, the second plurality of selectable inputs may comprise an eighth selectable input corresponding to reserving a lodging accommodation at a first hotel “Star Hotel” of the plurality of hotels 522. Alternatively and/or additionally, the second plurality of selectable inputs may comprise a ninth selectable input corresponding to reserving a lodging accommodation at a second hotel “Best Hotel” of the plurality of hotels 522. Alternatively and/or additionally, the second plurality of selectable inputs may comprise a tenth selectable input corresponding to reserving a lodging accommodation at a third hotel “Hotel Jerry” of the plurality of hotels 522.

In some examples, a plurality of destination locations 524 associated with the workplace location of the contact may be determined such that each destination location of the plurality of destination locations 524 is within a threshold distance from the workplace location of the contact. For example, the graphical user interface of the first client device 500 may be controlled to display indications of the plurality of destination locations 524. Alternatively and/or additionally, a second plurality of distances may be determined. Each distance of the second plurality of distances may correspond to a distance between the workplace location and a destination location of the plurality of destination locations 524. For example, the graphical user interface of the first client device 500 may be controlled to display indications of the second plurality of distances.

Alternatively and/or additionally, the graphical user interface of the first client device 500 may be controlled to display a third plurality of selectable inputs associated with the plurality of destination locations 524 and/or the contact. For example, the third plurality of selectable inputs may comprise an eleventh selectable input corresponding to scheduling a meeting with the contact at a first destination location “Las Vegas Aquarium” of the plurality of destination locations 524. Alternatively and/or additionally, the third plurality of selectable inputs may comprise a twelfth selectable input corresponding to scheduling a meeting with the contact at a second destination location “Kabab Restaurant” of the plurality of destination locations 524. Alternatively and/or additionally, the third plurality of selectable inputs may comprise a thirteenth selectable input corresponding to scheduling a meeting with the contact at a third destination location “30 Seasons Cafe” of the plurality of destination locations 524. In some examples, a selection of the thirteenth selectable input may be received. Responsive to receiving a selection of the thirteenth selectable input, a plurality of times associated with an availability of the contact may be determined. For example, the plurality of times may correspond to times that the contact is determined to be available.

FIG. 5E illustrates the graphical user interface of the first client device 500 being controlled to display the plurality of times associated with the availability of the contact. For example, the plurality of times may be determined based upon a work schedule associated with the contact, a second web-based calendar associated with the contact, etc. In some examples, the graphical user interface may be controlled to display a fourth plurality of selectable inputs 530 corresponding to the plurality of times. Alternatively and/or additionally, the graphical user interface may be controlled to display a fourteenth selectable input 532 corresponding to selecting a different time (e.g., different than the plurality of times). Responsive to receiving a selection of a fifteenth selectable input “7:00 PM-8:00 PM” of the fourth plurality of selectable inputs 530, a second notification may be transmitted to the second client device 575 of the contact comprising an indication that the user requests a meeting with the contact at the third destination location at a third time (e.g., 7:00 PM).

FIG. 5F illustrates a second graphical user interface of the second client device 575 being controlled to display the second notification. The second notification may comprise an indication that the user requests a meeting with the contact at the third destination at the third time. The second graphical user interface of the second client device 575 may be controlled to display a sixteenth selectable input 576 “Recommend a different time or place” corresponding to scheduling the meeting for a different time and/or a different destination location. Alternatively and/or additionally, the second graphical user interface of the second client device 575 may be controlled to display a seventeenth selectable input 578 “Accept invitation” corresponding to accepting the request to meet with the contact at the third destination at the third time. Alternatively and/or additionally, the second graphical user interface of the second client device 575 may be controlled to display an eighteenth selectable input 580 “Connect with Sam B.” corresponding to communicating with the user. For example, responsive to receiving a selection of the eighteenth selectable input 580, a second messaging interface may be presented such that a message may be inputted and/or transmitted to the first client device 500 associated with the user.

In some examples, a plurality of items 538 associated with one or more determined weather conditions of the location during the time may be determined. For example, the plurality of items 538 may be determined based upon one or more temperatures of the location during the time, one or more levels of sunshine of the location during the time and/or one or more different weather conditions.

FIG. 5G illustrates the graphical user interface of the first client device 500 being controlled to display the plurality of items 538. The plurality of items 538 may be comprised within a third notification transmitted to the first client device 500 before the time of the trip (e.g., 8 hours before the time, 1 day before the time, 3 days before the time, etc.). The graphical user interface of the first client device 500 may be controlled to display a fifth plurality of selectable inputs associated with the plurality of items 538. For example, the fifth plurality of selectable inputs may correspond to purchasing products associated with the plurality of items 538.

It may be appreciated that the disclosed subject matter may assist a user (e.g., and/or a first client device associated with the user) in determining one or more contacts that may be at or near a location that the user plans a trip to during a time of the trip, scheduling meeting times with one or more contacts that the user may want to meet with, determining one or more hotels associated with one or more places of residence and/or one or more workplaces of the one or more contacts, determining one or more destination locations that may be of interest to the user and/or that may be associated with the one or more places of residence and/or the one or more workplaces, and/or determining and/or purchasing one or more items associated with weather conditions of the location that may be beneficial for the user to take on the trip.

Implementation of at least some of the disclosed subject matter may lead to benefits including, but not limited to, a reduction in screen space and/or an improved usability of a display (e.g., of the first client device) (e.g., as a result of determining the one or more contacts that may be at or near the location of the trip such that a separate window and/or application may not need to be opened to determine the one or more contacts, as a result of determining the one or more hotels associated with the one or more places of residence and/or the one or more workplaces such that a separate window and/or application may not need to be opened to determine the one or more hotels, as a result of determining the one or more destination locations that may be of interest to the user and/or that may be associated with the one or more places of residence and/or the one or more workplaces such that a separate window and/or application may not need to be opened to determine the one or more destination locations, as a result of determining the one or more items associated with weather conditions of the location such that a separate window and/or application may not need to be opened to determine the weather conditions and/or appropriate clothing options associated with the weather conditions, etc.).

Alternatively and/or additionally, implementation of at least some of the disclosed subject matter may lead to benefits including a reduction in bandwidth (e.g., as a result of determining the one or more contacts that may be at or near the location of the trip such that additional data does not need to be consumed to determine the one or more contacts, as a result of determining the one or more hotels associated with the one or more places of residence and/or the one or more workplaces such that additional data does not need to be consumed to determine the one or more hotels, as a result of determining the one or more destination locations that may be of interest to the user and/or that may be associated with the one or more places of residence and/or the one or more workplaces such that additional data does not need to be consumed to determine the one or more destination locations, as a result of determining the one or more items associated with weather conditions of the location such that additional data does not need to be consumed to determine the weather conditions and/or appropriate clothing options associated with the weather conditions, etc.).

In some examples, at least some of the disclosed subject matter may be implemented on a client device, and in some examples, at least some of the disclosed subject matter may be implemented on a server (e.g., hosting a service accessible via a network, such as the Internet).

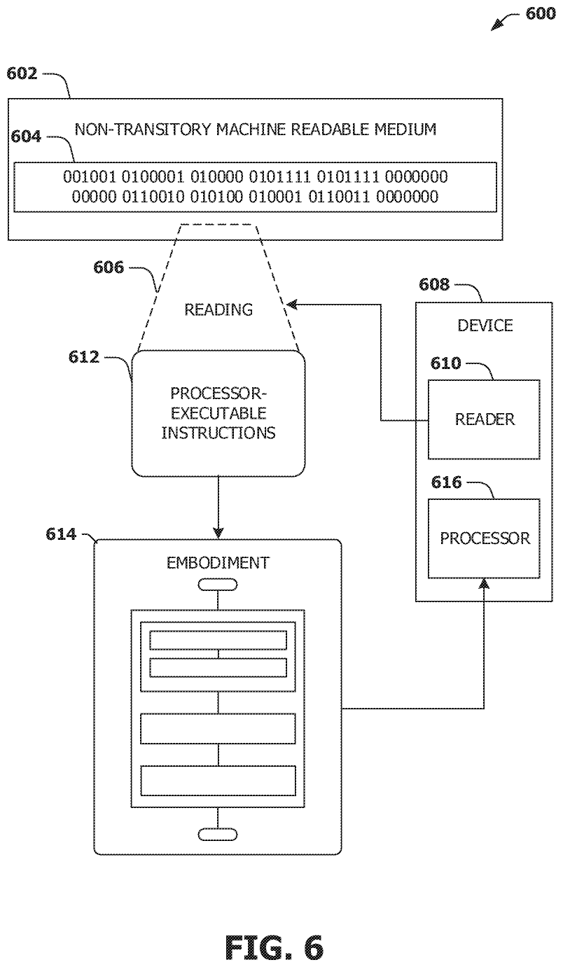

FIG. 6 is an illustration of a scenario 600 involving an example non-transitory machine readable medium 602. The non-transitory machine readable medium 602 may comprise processor-executable instructions 612 that when executed by a processor 616 cause performance (e.g., by the processor 616) of at least some of the provisions herein (e.g., embodiment 614). The non-transitory machine readable medium 602 may comprise a memory semiconductor (e.g., a semiconductor utilizing static random access memory (SRAM), dynamic random access memory (DRAM), and/or synchronous dynamic random access memory (SDRAM) technologies), a platter of a hard disk drive, a flash memory device, or a magnetic or optical disc (such as a compact disc (CD), digital versatile disc (DVD), or floppy disk). The example non-transitory machine readable medium 602 stores computer-readable data 604 that, when subjected to reading 606 by a reader 610 of a device 608 (e.g., a read head of a hard disk drive, or a read operation invoked on a solid-state storage device), express the processor-executable instructions 612. In some embodiments, the processor-executable instructions 612, when executed, cause performance of operations, such as at least some of the example method 400 of FIG. 4, for example. In some embodiments, the processor-executable instructions 612 are configured to cause implementation of a system, such as at least some of the example system 501 of FIGS. 5A-5G, for example.

3. Usage of Terms

As used in this application, “component,” “module,” “system”, “interface”, and/or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “example” is used herein to mean serving as an instance, illustration, etc., and not necessarily as advantageous. As used herein, “or” is intended to mean an inclusive “or” rather than an exclusive “or”. In addition, “a” and “an” as used in this application are generally be construed to mean “one or more” unless specified otherwise or clear from context to be directed to a singular form. Also, at least one of A and B and/or the like generally means A or B or both A and B. Furthermore, to the extent that “includes”, “having”, “has”, “with”, and/or variants thereof are used in either the detailed description or the claims, such terms are intended to be inclusive in a manner similar to the term “comprising”.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

Various operations of embodiments are provided herein. In an embodiment, one or more of the operations described may constitute computer readable instructions stored on one or more computer and/or machine readable media, which if executed will cause the operations to be performed. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein. Also, it will be understood that not all operations are necessary in some embodiments.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

What is claimed is:

1. A method, comprising:
determining a location associated with a trip of a first user, wherein the first user is associated with a first user account;
determining a time associated with the trip of the first user to the location;
generating a first location profile associated with the first user account, based upon the location and the time, wherein the first location profile comprises one or more locations associated with the first user and one or more times corresponding to the one or more locations;
determining a plurality of user accounts having a relationship with the first user account;
comparing a plurality of location profiles, associated with the plurality of user accounts, with the first location profile;
determining that one or more location profiles, associated with one or more user accounts of the plurality of user accounts, are associated with one or more second locations and one or more second times that match the location and the time, wherein the plurality of location profiles comprises the one or more location profiles; and
responsive to determining that the one or more second locations and the one or more second times match the location and the time, transmitting a notification to a first client device associated with the first user account, wherein the notification is indicative of the one or more second locations and the one or more second times matching the location and the time.

2. The method of claim 1, comprising:
assigning a plurality of weights to a second plurality of user accounts, wherein the second plurality of user accounts comprises the plurality of user accounts;
determining that each weight of a second plurality of weights associated with the plurality of user accounts is higher than a weight threshold; and
responsive to the determining that each weight of the second plurality of weights is higher than the weight threshold, selecting the plurality of location profiles for comparison with the first location profile.

3. The method of claim 2, wherein:
each weight of the plurality of weights is assigned to a user account of the second plurality of user accounts based upon an amount of communication between the first user account and the user account.

4. The method of claim 1, comprising:
determining one or more hotels associated with the one or more second locations of the one or more user accounts;
controlling a graphical user interface of the first client device to display one or more selectable inputs corresponding to the one or more hotels;
receiving a first selectable input, via the graphical user interface, corresponding to a first hotel of the one or more hotels; and
controlling the graphical user interface of the first client device to display a hotel reservation interface associated with the first hotel.

5. The method of claim 1, comprising:
determining one or more destination locations associated with the location;
controlling a graphical user interface of the first client device to display one or more indications of the one or more destination locations;
receiving, via the graphical user interface, one or more inputs corresponding to a first destination option of the one or more destination options and a second user account of the one or more user accounts; and
transmitting a second notification to a second client device associated with the second user account, wherein the second notification is indicative of the first destination option and the first user account.

6. The method of claim 1, comprising:
determining one or more items associated with one or more determined weather conditions of the location during the time; and
controlling a graphical user interface of the first client device to display one or more indications of the one or more items.

7. The method of claim 1, comprising:
determining one or more third times associated with an availability of a second user associated with a second user account of the one or more user accounts;
controlling a graphical user interface of the first client device to display one or more indications of the one or more third times;
receiving, via the graphical user interface, an input corresponding to a first time of the one or more third times; and
transmitting a second notification to a second client device associated with the second user account, wherein the second notification is indicative of the first time and the first user account.

8. The method of claim 1, comprising:
monitoring a web-based calendar associated with the first user account, wherein the location and the time are determined by identifying the location and the time in the web-based calendar.

9. The method of claim 1, comprising:
monitoring email messages associated with the first user account, wherein the location and the time are determined by identifying the location and the time in the email messages.

10. The method of claim 1, comprising:
monitoring social network activity associated with the first user account, wherein the location and the time are determined by identifying the location and the time in a social network message associated with the social network activity.

11. A computing device comprising:
a processor; and
memory comprising processor-executable instructions that when executed by the processor cause performance of operations, the operations comprising:
determining a location associated with a trip of a first user, wherein the first user is associated with a first user account;
determining a time associated with the trip of the first user to the location;
generating a first location profile associated with the first user account, based upon the location and the time, wherein the first location profile comprises one or more locations associated with the first user and one or more times corresponding to the one or more locations;
determining a plurality of user accounts having a relationship with the first user account;
comparing a plurality of location profiles, associated with the plurality of user accounts, with the first location profile;
determining that one or more location profiles, associated with one or more user accounts of the plurality of user accounts, are associated with one or more second locations and one or more second times that match the location and the time, wherein the plurality of location profiles comprises the one or more location profiles; and
responsive to determining that the one or more second locations and the one or more second times match the location and the time, transmitting a notification to a first client device associated with the first user account, wherein the notification is indicative of the one or more second locations and the one or more second times matching the location and the time.

12. The computing device of claim 11, the operations comprising:
assigning a plurality of weights to a second plurality of user accounts, wherein the second plurality of user accounts comprises the plurality of user accounts;
determining that each weight of a second plurality of weights associated with the plurality of user accounts is higher than a weight threshold; and
responsive to the determining that each weight of the second plurality of weights is higher than the weight threshold, selecting the plurality of location profiles for comparison with the first location profile.

13. The computing device of claim 12, wherein:
each weight of the plurality of weights is assigned to a user account of the second plurality of user accounts based upon an amount of communication between the first user account and the user account.

14. The computing device of claim 11, the operations comprising:
determining one or more hotels associated with the one or more second locations of the one or more user accounts;
controlling a graphical user interface of the first client device to display one or more selectable inputs corresponding to the one or more hotels;
receiving a first selectable input, via the graphical user interface, corresponding to a first hotel of the one or more hotels; and
controlling the graphical user interface of the first client device to display a hotel reservation interface associated with the first hotel.

15. The computing device of claim 11, the operations comprising:
determining one or more destination locations associated with the location;
controlling a graphical user interface of the first client device to display one or more indications of the one or more destination locations;
receiving, via the graphical user interface, one or more inputs corresponding to a first destination option of the one or more destination options and a second user account of the one or more user accounts; and
transmitting a second notification to a second client device associated with the second user account, wherein the second notification is indicative of the first destination option and the first user account.

16. A non-transitory machine readable medium having stored thereon processor-executable instructions that when executed cause performance of operations, the operations comprising:
determining a location associated with a trip of a first user, wherein the first user is associated with a first user account;
determining a time associated with the trip of the first user to the location;
generating a first location profile associated with the first user account, based upon the location and the time, wherein the first location profile comprises one or more locations associated with the first user and one or more times corresponding to the one or more locations;
determining a plurality of user accounts having a relationship with the first user account;
comparing a plurality of location profiles, associated with the plurality of user accounts, with the first location profile;
determining that one or more location profiles, associated with one or more user accounts of the plurality of user accounts, are associated with one or more second locations and one or more second times that match the location and the time, wherein the plurality of location profiles comprises the one or more location profiles; and
responsive to determining that the one or more second locations and the one or more second times match the location and the time, transmitting a notification to a first client device associated with the first user account, wherein the notification is indicative of the one or more second locations and the one or more second times matching the location and the time.

17. The non-transitory machine readable medium of claim 16, the operations comprising:
assigning a plurality of weights to a second plurality of user accounts, wherein the second plurality of user accounts comprises the plurality of user accounts;
determining that each weight of a second plurality of weights associated with the plurality of user accounts is higher than a weight threshold; and
responsive to the determining that each weight of the second plurality of weights is higher than the weight threshold, selecting the plurality of location profiles for comparison with the first location profile.

18. The non-transitory machine readable medium of claim 17, wherein:
each weight of the plurality of weights is assigned to a user account of the second plurality of user accounts based upon an amount of communication between the first user account and the user account.

19. The non-transitory machine readable medium of claim 16, the operations comprising:
determining one or more hotels associated with the one or more second locations of the one or more user accounts;
controlling a graphical user interface of the first client device to display one or more selectable inputs corresponding to the one or more hotels;
receiving a first selectable input, via the graphical user interface, corresponding to a first hotel of the one or more hotels; and
controlling the graphical user interface of the first client device to display a hotel reservation interface associated with the first hotel.

20. The non-transitory machine readable medium of claim 16, the operations comprising:
determining one or more destination locations associated with the location;
controlling a graphical user interface of the first client device to display one or more indications of the one or more destination locations;
receiving, via the graphical user interface, one or more inputs corresponding to a first destination option of the one or more destination options and a second user account of the one or more user accounts; and
transmitting a second notification to a second client device associated with the second user account, wherein the second notification is indicative of the first destination option and the first user account.
